(19) United States
(12) Patent Application Publication
(10) Pub. No.: US 2020/0071438 A1
(43) Pub. Date: Mar. 5, 2020

(54) Processes for Preparing a Catalyst System and Polymerizing Olefins

(71) Applicant: ExxonMobil Chemical Patents Inc., Baytown, TX (US)

(72) Inventors: Corrine L. Brandl, Beaumont, TX (US); Fred D. Ehrman, Houston, TX (US); Edward F. Smith, Houston, TX (US); Chi-I Kuo, Atascocita, TX (US)

(21) Appl. No.: 16/492,996

(22) PCT Filed: Feb. 28, 2018
(86) PCT No.: PCT/US2018/020119

§ 371 Date: Sep. 11, 2019

Related U.S. Application Data
(60) Provisional application No. 62/474,153, filed on Mar. 21, 2017.

(51) Int. Cl. C08F 210/16

(52) U.S. Cl. CPC C08F 210/16; C08F 2410/01

(57) ABSTRACT

A process for preparing a catalyst system including contacting one or more catalysts having a Group 3 through Group 12 metal atom or lanthanide metal atom with a methylalumoxane and one or more support material compositions to a concentration of methylalumoxane of about 4 mmol to about 15 mmol aluminum per gram of support material is provided. The support material composition may have a macroporosity of from about 0.18 cc/g to about 0.50 cc/g. In other embodiments, a process for polymerizing at least one olefin to produce a polyolefin composition including contacting one or more olefins with the aforementioned catalyst system is also provide.

### CROSS REFERENCE TO RELATED APPLICATIONS

This application claims the benefit of Ser. No. 62/474,153, filed Mar. 21, 2017, the disclosure of which is hereby incorporated by reference in its entirety.

### FIELD OF THE INVENTION

The present disclosure relates to catalyst systems for olefin polymerization, processes for preparing the catalyst systems, and processes for polymerizing olefins to produce polyolefin compositions.

### BACKGROUND OF THE INVENTION

Polyolefin polymers are widely used commercially because of their robust physical properties. For example, various types of polyethylene polymers, including high density, low density and linear low density polyethylenes, are some of the most commercially useful. Polyolefin polymers are typically prepared with a catalyst that polymerizes olefin monomers in a reactor, such as a gas phase, fluidize bed reactor.

For many years, “sheeting” and “chunking” have occurred in commercial gas phase polyolefin production reactors. Sheeting and chunking are characterized by the formation of solid masses of polymer on the internal walls of the reactor in the form of sheets or chunks. Small granules (also known as “fines”) typically have a diameter of less than about 125 microns. High levels of fines can lead to sheeting. These solid chunks or sheets are made predominantly of agglomerated polymer granules and eventually become dislodged from the walls and/or dome of the reactor and fall into the reaction section, where they can interfere with fluidization, block the product discharge ports, and/or can force a reactor shut-down for cleaning. Any one of these events can be described as a “discontinuity event” because the event disrupts the continuous operation of the polymerization reactor.

There are at least two forms of sheeting that occur in gas phase reactors known as “wall sheets” or “dome sheets,” depending on where they are formed in the reactor. Wall sheets are formed on the internal walls (generally vertical sections) of the reaction section. Dome sheets are formed much higher in the reactor, on the conical section of the expanded section or on the hemi-spherical head on the top of the reactor.

When sheeting occurs with Ziegler-Natta catalysts, it typically occurs in the lower section of the reactor and is referred to as wall sheeting. Ziegler-Natta catalysts are capable of forming dome sheets, but the occurrence is rare. But with metallocene catalysts, sheeting can occur in either location or both locations, that is, both wall sheeting and dome sheeting can typically occur.

Typical metallocene catalysts are generally described as containing one or more ligands capable of bonding to the transition metal atom, usually, cyclopentadienyl derived ligands or moieties, in combination with a transition metal selected from Group 4, 5 or 6 or from the lanthanide and actinide series of the Periodic Table of Elements.

One characteristic that makes it difficult to control sheeting with metallocene catalysts is their unpredictable tendency to promote static buildup in a reactor. For example, erratic static charge behavior can appear after long periods of stable behavior, sometimes correlating with a change in properties of the polymer being produced. As a result of the reactor discontinuity associated with using metallocene catalysts, various techniques have been developed that attempt to improve operability by, for example, adding an inert hydrocarbon to the reactor, using sound waves to reduce sheeting, and adding antistatic agents or continuity additives directly to the reactor. Nonetheless, the sheeting problem persists. One reason the problem persists is that the use of additives can be accompanied by decreased catalyst efficiencies and productivities.

Thus, there is a need for catalyst systems that provide for the reduction or elimination of sheeting and/or chunking in an olefin polymerization reactor during operation. There is also a need for processes of polymerizing olefins with reduced sheeting and/or chunking and, accordingly, reduced or eliminated reactor discontinuity events.

### SUMMARY OF THE INVENTION

In a class of embodiments, the present disclosure provides for a process for preparing a catalyst system comprising contacting a catalyst having a Group 3 through Group 12 metal atom or lanthanide metal atom with a methylalumoxane, and a support material composition to a concentration of methylalumoxane of about 4 mmol to about 15 mmol aluminum per gram of support material. The support material composition may have a macroporosity from about 0.18 cc/g to about 0.30 cc/g.

In another class of embodiments, the present disclosure provides for a process for polymerizing olefins to produce a polyolefin composition, the process comprising contacting one or more olefins with a catalyst system comprising a catalyst a Group 3 through Group 12 metal atom or lanthanide metal atom, at least one activator, and a support material composition having a macroporosity from about 0.18 cc/g to about 0.30 cc/g, and obtaining the polyolefin composition at a space time yield of about 14 lb/hr/ft³ or greater.

Other embodiments of the invention are described and claimed herein and are apparent by the following disclosure.

### BRIEF DESCRIPTION OF THE DRAWING

FIG. 1 is a graph illustrating skin temperature of a gas phase reactor versus time for polyethylene polymerizations using a variety of catalyst systems.

### DETAILED DESCRIPTION

Before the present compounds, components, compositions, and/or methods are disclosed and described, it is to be understood that unless otherwise indicated this invention is not limited to specific compounds, components, compositions, reactants, reaction conditions, ligands, metallocene structures, or the like, as such may vary, unless otherwise specified. It is also to be understood that the terminology used herein is for the purpose of describing particular embodiments only and is not intended to be limiting.

Embodiments of the present disclosure include a catalyst system comprising a support material composition and a catalyst compound having a Group 3 through Group 12 metal atom or lanthanide metal atom. The support material composition comprises support material particles. The support material composition can be an agglomerate of these support material particles. The support material composition may have a macroporosity from about 0.15 cc/g to about 0.50 cc/g, such as from about 0.18 cc/g to about 0.30 cc/g. It has been discovered that a catalyst system having a support material composition having a macroporosity from about 0.15 cc/g to about 0.50 cc/g provides catalyst systems having increased catalyst deposition on and/or in the support material. In many of the embodiments of the invention, the increased catalyst content does not substantially affect catalyst activity of catalyst systems. In a class of embodiments, the support material composition having a macroporosity from about 0.15 cc/g to about 0.50 cc/g further provides reduced sheeting and/or chunking within a reactor, for example, a gas phase fluidized bed reactor, during polymerization or operation.

The catalyst having a Group 3 through Group 12 metal atom or lanthanide metal atom may be a metallocene catalyst compound. In at least one embodiment, the support material comprises Al₂O₃, ZrO₂, SiO₂, SiO₂/Al₂O₃, SiO₂/TiO₂, silica-alumina, silica clay, silicon oxide/clay, or mixture thereof.

Catalyst systems of the present disclosure may include at least one activator. The activator may be an alkylalumoxane such as methylalumoxane. The alkylalumoxane may be present in the catalyst system at a molar ratio of aluminum to catalyst metal of from about 1:1 to about 200:1, such as from 50:1 to about 200:1, or about 50:1 or less. Catalyst systems of the present disclosure may have an aluminum content (of the alkylalumoxane) of from about 4 mmol to about 15 mmol, such as 5 mmol-12 mmol Al per gram of support material, such as silica.

In a class of embodiment, it has been discovered that a catalyst system having a support material composition having a macroporosity from about 0.15 cc/g to about 0.50 cc/g provides catalyst systems having increased catalyst content within and/or on the support material. In at least one embodiment, the support material composition has a macroporosity from about 0.20 cc/g to about 0.30 cc/g, such as from about 0.22 cc/g to about 0.28 cc/g, such as from about 0.24 cc/g to about 0.26 cc/g, for example about 0.25 cc/g.

For example, if the support material composition is SiO₂, the catalyst system can have an uncrushed (Al/Si)/crushed (Al/Si) value of from about 1 to about 3, such as from about 1 to about 2, as determined by X-ray Photoelectron Spectroscopy. As used herein, the term “crushed” is defined as a material that has been ground into fine particles via mortar and pestal. As used herein, the term “uncrushed” is defined as a material that has not been ground into fine particles via mortar and pestal. To measure an uncrushed (Al/Si)/crushed (Al/Si) value, an X-ray Photoelectron spectrum is obtained for a catalyst system. The metal content of the outer surface of the catalyst system is determined as a wt % of the outer surface using the spectrum. Then, the catalyst system is ground into fine particles using a mortar and a pestal. A subsequent X-ray Photoelectron spectrum is obtained for the fine particles, and metal content of the fine particle surfaces is determined as a wt % using the subsequent X-Ray Photoelectron spectrum. The wt % value determined for the uncrushed catalyst system is divided by the wt % value for the crushed catalyst system (i.e., the fine particles) to provide an uncrushed/crushed value. A value of 1 indicates completely uniform metal distribution on the outer surface and surfaces within void spaces within the catalyst system. A value of greater than 1 indicates a greater amount of metal on the outer surface of the support material composition than in the voids of the support material composition. A value of less than 1 indicates a greater amount of metal on the surface of the support material composition within the voids than metal on the outer surface of the support material composition.

Support material compositions of the present disclosure can have a plurality of particles and one or more of the plurality of particles can have a surface area from about 270 m²/g to about 350 m²/g and a pore volume (mesoporosity) from about 1.2 cc/g to about 3.0 cc/g. In at least one embodiment, the support material composition comprises a plurality of particles and one or more of the plurality of particles has a surface area from about 700 m²/g to about 850 m²/g, and a pore volume from about 0.6 cc/g to about 2.5 cc/g.

One or more of the plurality of particles can have a particle size diameter D50 value of from about 1 micron to about 5 microns. Furthermore, the support material composition can have a particle size D50 value of from about 20 microns to about 60 microns. In at least one embodiment, the support material composition has a particle size diameter D50 value of about 40 microns.

For purposes of the present disclosure, the numbering scheme for the Periodic Table Groups is used as described in CHEMICAL AND ENGINEERING NEWS, 63(5), pg. 27 (1985). Therefore, a “Group 4 metal” is an element from group 4 of the Periodic Table, e.g., Hf, Ti, or Zr.

“Catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹ hr⁻¹. Conversion is the amount of monomer that is converted to polymer product, and is reported as mol % and is calculated based on the polymer yield (weight) and the amount of monomer fed into the reactor. Catalyst activity is a measure of the level of activity of the catalyst and is reported as the mass of product polymer (P) produced per mass of supported catalyst (cat) (gP/g supported cat). In an at least one embodiment, the activity of the catalyst is at least 800 gpolymer/gsupported catalyst/hour, such as about 1,000 or more gpolymer/gsupported catalyst/hour, such as about 2,000 or more gpolymer/gsupported catalyst/hour, such as about 3,000 or more gpolymer/gsupported catalyst/hour, such as about 4,000 or more gpolymer/gsupported catalyst/hour, such as about 5,000 or more gpolymer/gsupported catalyst/hour.

An “olefin,” alternatively referred to as “alkene,” is a linear, branched, or cyclic compound of carbon and hydrogen having at least one double bond. When a polymer or copolymer is referred to as comprising an olefin, the olefin present in such polymer or copolymer is the polymerized form of the olefin. For example, when a copolymer is said to have an ethylene content of 35 wt % to 55 wt %, it is understood that the monomer (“mer”) unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of “copolymer,” as used herein, includes terpolymers and the like. An oligomer is typically a polymer having a low molecular weight, such an Mn of less than 25,000 g/mol, or less than 2,500 g/mol, or a low number of mer units, such as 75 mer units or less or 50 mer units or less. An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on.

A “catalyst system” is a combination of at least one catalyst compound and a support material. The catalyst system may have at least one activator and/or at least one co-activator. When catalyst systems are described as comprising neutral stable forms of the components, it is well understood that the ionic form of the component is the form that reacts with the monomers to produce polymers. For purposes of the present disclosure, “catalyst system” includes both neutral and ionic forms of the components of a catalyst system.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

In the present disclosure, the catalyst may be described as a catalyst precursor, a pre-catalyst compound, catalyst compound or a transition metal compound, and these terms are used interchangeably. An “anionic ligand” is a negatively charged ligand which donates one or more pairs of electrons to a metal ion. A “neutral donor ligand” is a neutrally charged ligand which donates one or more pairs of electrons to a metal ion.

For purposes of the present disclosure in relation to catalyst compounds, the term “substituted” means that a hydrogen group has been replaced with a hydrocarbyl group, a heteroatom, or a heteroatom containing group. For example, methylcyclopentadiene (MeCp) is a Cp group substituted with a methyl group, ethyl alcohol is an ethyl group substituted with an —OH group.

For purposes of the present disclosure, “alkoxides” include those where the alkyl group is a C1 to C10 hydrocarbyl. The alkyl group may be straight chain, branched, or cyclic. The alkyl group may be saturated or unsaturated. In at least one embodiment, the alkyl group may comprise at least one aromatic group. The term “alkoxy” or “alkoxide” preferably means an alkyl ether or aryl ether radical wherein the term alkyl is a C1 to C10 alkyl. Examples of suitable alkyl ether radicals include, but are not limited to, methoxy, ethoxy, n-propoxy, iso-propoxy, n-butoxy, iso-butoxy, sec-butoxy, tert-butoxy, phenoxy, and the like.

The present disclosure describes transition metal complexes. The term complex is used to describe molecules in which an ancillary ligand is coordinated to a central transition metal atom. The ligand is stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization function using an activator which is believed to create a cation as a result of the removal of an anionic group, often referred to as a leaving group, from the transition metal.

When used in the present disclosure, the following abbreviations mean: dme is 1,2-dimethoxyethane, Me is methyl, Ph is phenyl, Et is ethyl, Pr is propyl, iPr is isopropyl, n-Pr is normal propyl, cPr is cyclopropyl, Bu is butyl, iBu is isobutyl, tBu is tertiary butyl, p-tBu is para-tertiary butyl, nBu is normal butyl, sBu is sec-butyl, TMS is trimethylsilyl, TIBAL is triisobutylaluminum, TNOAL is tri(n-octyl)aluminum, MAO is methylalumoxane, sMAO is supported methylalumoxane, p-Me is para-methyl, Bn is benzyl (i.e., CH₂Ph), THF (also referred to as thf) is tetrahydrofuran, RT is room temperature (and is 23° C. unless otherwise indicated), tol is toluene, EtOAc is ethyl acetate, and Cy is cyclohexyl.

The terms “hydrocarbyl radical,” “hydrocarbyl,” “hydrocarbyl group,” “alkyl radical,” and “alkyl” are used interchangeably throughout this disclosure. Likewise, the terms “group”, “radical”, and “substituent” are also used interchangeably in this disclosure. For purposes of this disclosure, “hydrocarbyl radical” is defined to be C1-C100 radicals, that may be linear, branched, or cyclic, and when cyclic, aromatic or non-aromatic. Examples of such radicals include, but are not limited to, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted hydrocarbyl radicals are radicals in which at least one hydrogen atom of the hydrocarbyl radical has been substituted with at least a non-hydrogen group, such as halogen (such as Br, Cl, F or I) or at least one functional group such as NR*₂, OR*, SeR*, TeR*, PR*₂, AsR*₂, SbR*₂, SR*, BR*₂, SiR*₃, GeR*₃, SnR*₃, PbR*₃, and the like, or where at least one heteroatom has been inserted within a hydrocarbyl ring.

The term “alkenyl” means a straight-chain, branched-chain, or cyclic hydrocarbon radical having one or more carbon-carbon double bonds. These alkenyl radicals may be substituted. Examples of suitable alkenyl radicals include, but are not limited to, ethenyl, propenyl, allyl, 1,4-butadienyl, cyclopropenyl, cyclobutenyl, cyclopentenyl, cyclohexenyl, cycloctenyl and the like including their substituted analogues.

The term “aryl” or “aryl group” means a carbon-containing aromatic ring and the substituted variants thereof, including but not limited to, phenyl, 2-methyl-phenyl, xylyl, 4-bromo-xylyl. Likewise, heteroaryl means an aryl group where a ring carbon atom (or two or three ring carbon atoms) has been replaced with a heteroatom, preferably N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has 5 ring atoms. A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

“Complex” as used herein, is also often referred to as catalyst precursor, precatalyst, catalyst, catalyst compound, transition metal compound, or transition metal complex. These terms are used interchangeably. Activator and cocatalyst are also used interchangeably.

In the present disclosure, a catalyst may be described as a catalyst precursor, a pre-catalyst compound, catalyst compound or a transition metal compound, and these terms are used interchangeably. A polymerization catalyst system is a catalyst system that can polymerize monomers into polymer.

The term “continuous” means a system that operates without interruption or cessation for a period of time. For example, a continuous process to produce a polymer would be one where the reactants are continually introduced into one or more reactors and polymer product is continually withdrawn.

### Support Material Compositions

Embodiments of the present disclosure include a catalyst system comprising a support material composition and a catalyst having a Group 3 through Group 12 metal atom or lanthanide metal atom. The support material composition comprises support material particles. The support material composition can be an agglomerate of the support material particles. As used herein, the term “agglomerate” is defined as a composition of particles having sufficient interactive forces as to form a cluster of particles having voids within the cluster, e.g. a macroporosity. A support material composition of the present disclosure has a macroporosity from about 0.15 cc/g to about 0.50 cc/g. In at least one embodiment, the support material composition has a macroporosity from about 0.18 cc/g to about 0.30 cc/g, such as from about 0.20 cc/g to about 0.30 cc/g, such as from about 0.22 cc/g to about 0.28 cc/g, such as from about 0.24 cc/g to about 0.26 cc/g, for example about 0.25 cc/g.

A support material composition of the present disclosure having a macroporosity from about 0.15 cc/g to about 0.50 cc/g can be synthesized (e.g., by spray drying) or obtained commercially.

It has been discovered that a catalyst system having a support material composition having a macroporosity from about 0.15 cc/g to about 0.50 cc/g provides catalyst systems having increased catalyst content within the support material and provides reduced sheeting and chunking with a reactor during polymerization.

The support material composition can be made of a plurality of particles. One or more of the plurality of particles can have a surface area from about 10 m²/g to about 700 m²/g, pore volume (mesoporosity) from about 0.1 to about 4.0 cc/g and average particle size from about 5 m to about 500 μm. In at least one embodiment, the surface area of one or more of the plurality of particles is from about 50 m²/g to about 500 m²/g, pore volume from about 0.5 cc/g to about 3.5 cc/g, and average particle size from about 10 m to about 200 μm. The surface area of one or more of the plurality of particles may be from about 100 m²/g to about 400 m²/g, pore volume from about 0.8 to about 3.0 cc/g and average particle size from about 5 to about 100 μm.

The average pore size (diameter) of one or more of the plurality of particles may be from about 10 to about 1000 Å, such as from about 50 to about 500 Å, such as from about 75 to about 350 Å. In at least one embodiment, one or more of the plurality of particles is a high surface area, amorphous silica (surface area=300 m²/gm; pore volume of 1.65 cm³/gm).

In at least one embodiment, one or more of the plurality of particles has a surface area from about 270 m²/g to about 350 m²/g and a pore volume (mesoporosity) from about 1.2 cc/g to about 3 cc/g. In at least one embodiment, one or more of the plurality of particles has a surface area from about 700 m²/g to about 850 m²/g and a pore volume from about 0.6 cc/g to about 2.5 cc/g.

One or more of the plurality of particles has a volume size diameter from about 1 to about 300 microns. The term diameter is used to refer to the particle size as measured by light scattering, though it is not meant to imply that the particles are necessarily spherical in shape. The volume size diameter is also referred to as the volume moment mean of the particles, or D[4,3]=Σnᵢdᵢ⁴/Σnᵢdᵢ³ summed over all particles i.

Volume size diameter may be measured by particle size analysis via light scattering using an apparatus such as a Malvern™ Mastersizer. This instrument, made by Malvern Instruments, Malvern, Worcestershire, utilizes Mie theory to calculate the particle size distribution. Mie theory predicts how light is scattered by spherical particles and takes into account the refractive index of the particles. The real value used for silica refractive index is 1.45 and 0.1 is used for the imaginary refractive index of the particle (corresponding to the absorption of light), with a water dispersant at 1.33 refractive index.

When considering the particle size distribution, as opposed to the mean particle size, the plurality of particles suitably has a D90 of about 500 μm or less, such as about 400 or less. They may have a D50 of about 300 μm or less. The plurality of particles may have D10 of about 10 μm or less, such as about 1 μm or less. (For the sake of clarity, D90 is the diameter at which 90% by volume of the plurality of particles have a diameter less than D90. D50 is the diameter at which 50% by volume of the plurality of particles have a diameter less than D50. D10 is the diameter at which 10% by volume of the plurality of particles have a diameter less than D10.) The plurality of particles has a D50 from about 1 μm to about 300 μm, such as from about 1 μm to about 250 μm, such as from about 1 μm to about 150 pin, for example about 1 μm to about 5 μm.

In at least one embodiment, the support material particles are an inert support material. The support material particles may be a porous support material, for example, talc or inorganic oxides. Other support materials include zeolites, clays, organoclays, or any other organic or inorganic support material and the like, or mixtures thereof.

In at least one embodiment, the support material particles are an inorganic oxide in a finely divided form. Suitable inorganic oxide materials for use as support material particles herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support material particles, however, can be employed, for example, finely divided functionalized polyolefins, such as finely divided polyethylene. Particularly useful support material particles include magnesia, titania, zirconia, montmorillonite, phyllosilicate, zeolites, talc, clays, and the like. Also, combinations of these support material particles may be used, for example, silica-chromium, silica-alumina, silica-titania, and the like. In at least one embodiment, the support material particles are selected from Al₂O₃, ZrO₂, SiO₂, SiO₂/Al₂O₂, silica clay, silicon oxide/clay, or mixtures thereof.

The support material particles may include fluorine, e.g. the support material may be fluorided. As used herein, the phrases “fluorided support material particle”, “fluorided support”, and “fluorided support material composition” mean a support, desirably particulate and porous, which has been treated with at least one inorganic fluorine containing compound. For example, the fluorided support composition particles can be silicon dioxide support particles where a portion of the silica hydroxyl groups has been replaced with fluorine or fluorine containing compounds. Suitable fluorine containing compounds include, but are not limited to, inorganic fluorine containing compounds and/or organic fluorine containing compounds.

Fluorine compounds suitable for providing fluorine for the support may be organic or inorganic fluorine compounds and are desirably inorganic fluorine containing compounds. Such inorganic fluorine containing compounds may be any compound containing a fluorine atom as long as it does not contain a carbon atom. Particularly desirable are inorganic fluorine-containing compounds selected from NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, IF₇, NF₃, HF, BF₃, NHF₂, NH₄HF₂, and combinations thereof. In at least one embodiment, ammonium hexafluorosilicate and ammonium tetrafluoroborate are used.

The plurality of particles can be coupled, adhered, or otherwise suitably interacted with each other to form a support material composition. A support material composition can be an agglomerate of these support material particles. A support material composition can be formed by spray drying the plurality of particles or obtained commercially.

Support material compositions of the present disclosure have a macroporosity from about 0.15 cc/g to about 0.50 cc/g. In at least one embodiment, the support material composition has a macroporosity from about 0.18 cc/g to about 0.30 cc/g, such as from about 0.2 cc/g to about 0.3 cc/g, such as from about 0.22 cc/g to about 0.28 cc/g, such as from about 0.24 cc/g to about 0.26 cc/g. As used herein, the term “macroporosity” is defined as the total void space present between the plurality of particles of a support material composition. Macroporosity can be determined by any suitable Mercury Intrusion porosimeter, such as the NanoPlus HD from MicroMeritics Instrument Corporation of Norcross, Ga., according to ASTM D4284-12 or ASTM D4404-10. ASTM D4284-12 is applied unless otherwise stated.

Furthermore, the support material composition can have a particle size D50 value of from about 10 microns (μm) to about 400 microns, such as from about 30 microns to about 100 microns, such as from about 30 microns to about 60 microns. In at least one embodiment, the support material composition has a particle size diameter D50 value of about 40 microns.

The support material composition should be dry, that is, free of absorbed water. Drying of the support material composition can be effected by heating or calcining at from about 100° C. to about 1000° C., such as at least about 600° C. When the support material composition is silica, it is heated to at least 200° C., such as from about 200° C. to about 850° C., such as about 600° C.; and for a time from about 1 minute to about 100 hours, from about 12 hours to about 72 hours, or from about 24 hours to about 60 hours. The calcined support material composition can have at least some reactive hydroxyl (OH) groups.

A support material composition is then contacted with at least one polymerization catalyst and an activator. The support material composition, having reactive surface groups, typically hydroxyl groups, is slurried in a non-polar solvent and the resulting slurry is contacted with a solution of at least one catalyst compound and an activator. In at least one embodiment, the slurry of the support material composition is first contacted with the activator for a period of time from about 0.5 hours to about 24 hours, such as from about 2 hours to about 16 hours, or from about 4 hours to about 8 hours. The solution of the catalyst compound is then contacted with the isolated support material composition/activator. In at least one embodiment, the supported catalyst system is generated in situ. In at least one embodiment, the slurry of the support material composition is first contacted with the catalyst compound for a period of time from about 0.5 hours to about 24 hours, such as from about 2 hours to about 16 hours, or from about 4 hours to about 8 hours. The slurry of the supported catalyst compound(s) is then contacted with the activator solution.

The mixture of the catalyst, activator and support material composition may be heated to from about 0° C. to about 70° C., such as from about 23° C. to about 60° C., for example room temperature. Contact times may be from about 0.5 hours to about 24 hours, such as from about 2 hours to about 16 hours, or from about 4 hours to about 8 hours.

Suitable non-polar solvents are materials in which all of the reactants used herein, e.g., the activator, and the catalyst compound, are at least partially soluble and which are liquid at reaction temperatures. Non-limiting example non-polar solvents are alkanes, such as isopentane, hexane, n-heptane, octane, nonane, and decane, cycloalkanes, such as cyclohexane, aromatics, such as benzene, toluene, and ethylbenzene.

### Catalysts

In at least one embodiment, the present disclosure provides a catalyst system comprising a catalyst having a metal atom. “Catalyst” or “catalyst compound” may be used interchangeably unless otherwise stated. The catalyst can be a metallocene catalyst compound. The metal can be a Group 3 through Group 12 metal atom, such as Group 3 through Group 10 metal atoms, or lanthanide Group atoms. The catalyst having a Group 3 through Group 12 metal atom can be monodentate or multidentate, such as bidentate, tridentate, or tetradentate, where a heteroatom of the catalyst, such as phosphorous, oxygen, nitrogen, or sulfur is chelated to the metal atom of the catalyst. Non-limiting examples include bis(phenolate)s. In at least one embodiment, the Group 3 through Group 12 metal atom is selected from Group 5, Group 6, Group 8, or Group 10 metal atoms. In at least one embodiment, a Group 3 through Group 10 metal atom is selected from Cr, Sc, Ti, Zr, Hf, V, Nb, Ta, Mn, Re, Fe, Ru, Os, Co, Rh, Ir, and Ni. In at least one embodiment, a metal atom is selected from Groups 4, 5, and 6 metal atoms. In at least one embodiment, a metal atom is a Group 4 metal atom selected from Ti, Zr, or Hf. The oxidation state of the metal atom can range from 0 to +7, for example +1, +2, +3, +4, or +5, for example +2, +3 or +4.

Metallocene catalyst compounds as used herein include metallocenes comprising Group 3 to Group 12 metal complexes, preferably, Group 4 to Group 6 metal complexes, for example, Group 4 metal complexes. The metallocene catalyst compound of catalyst systems of the present disclosure may be unbridged metallocene catalyst compounds represented by the formula: Cp^{A}Cp^{B}M′X′ₙ, wherein each Cp^{A} and Cp^{B} is independently selected from cyclopentadienyl ligands and ligands isolobal to cyclopentadienyl, one or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, germanium, ether, and thioether.

In at least one embodiment, each Cp^{A} and Cp^{B} is independently selected from cyclopentadienyl, indenyl, fluorenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, and hydrogenated versions thereof.

The metallocene catalyst compound may be a bridged metallocene catalyst compound represented by the formula: Cp^{A}(A)Cp^{B}M′X′ₙ, wherein each Cp^{A} and Cp^{B} is independently selected from cyclopentadienyl ligands and ligands isolobal to cyclopentadienyl. One or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. (A) is selected from divalent alkyl, divalent lower alkyl, divalent substituted alkyl, divalent heteroalkyl, divalent alkenyl, divalent lower alkenyl, divalent substituted alkenyl, divalent heteroalkenyl, divalent alkynyl, divalent lower alkynyl, divalent substituted alkynyl, divalent heteroalkynyl, divalent alkoxy, divalent lower alkoxy, divalent aryloxy, divalent alkylthio, divalent lower alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent lower hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, germanium, ether, and thioether.

In at least one embodiment, each of Cp^{A} and Cp^{B} is independently selected from cyclopentadienyl, n-propylcyclopentadienyl, indenyl, pentamethylcyclopentadienyl, tetramethylcyclopentadienyl, and n-butylcyclopentadienyl.

(A) may be O, S, NR′, or SiR′₂, where each R′ is independently hydrogen or C1-C20 hydrocarbyl.

In another embodiment, the metallocene catalyst compound is represented by the formula:

T_{y}CpₘMGₙX_{q},

where Cp is independently a substituted or unsubstituted cyclopentadienyl ligand or substituted or unsubstituted ligand isolobal to cyclopentadienyl. M is a Group 4 transition metal. G is a heteroatom group represented by the formula JR*_{z} where J is N, P, O or S, and R* is a linear, branched, or cyclic C1-C20 hydrocarbyl, z is 1 or 2, T is a bridging group, y is 0 or 1, X is a leaving group, m=1, n=1, 2 or 3, q=0, 1, 2 or 3, and the sum of m+n+q is equal to the oxidation state of the transition metal.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof.

The metallocene catalyst compound may be selected from:
dimethylsilyl-bis(tetrahydroindenyl) zirconium dichloride;
dimethylsilyl (tetramethylcyclopentadienyl)(cyclododecylamido)titanium dimethyl;
dimethylsilyl (tetramethylcyclopentadienyl)(cyclododecylamido)titanium dichloride;
dimethylsilyl (tetramethylcyclopentadienyl)(t-butylamido)titanium dimethyl;
dimethylsilyl (tetramethylcyclopentadienyl)(t-butylamido)titanium dichloride;
μ-(CH₃)₂Si(cyclopentadienyl)(1-adamantylamido)M(R)₂;
μ-(CH₃)₂Si(3-tertbutylcyclopentadienyl)(1-adamantylamido)M(R)₂;
μ-(CH₃)₂(tetramethylcyclopentadienyl)(1-adamantylamido)M(R)₂;
μ-(CH₃)₂Si(tetramethylcyclopentadienyl)(1-adamantylamido)M(R)₂;
μ-(CH₃)₂C(tetramethylcyclopentadienyl)(1-adamantylamido)M(R)₂;
μ-(CH₃)₂Si(tetramethylcyclopentadienyl)(1-tertbutylamido)M(R)₂;
μ-(CH₃)₂Si(fluorenyl)(1-tertbutylamido)M(R)₂;
μ-(CH₃)₂Si(tetramethylcyclopentadienyl)(1-cyclododecylamido)M(R)₂;
μ-(C₆H₅)₂C(tetramethylcyclopentadienyl)(1-cyclododecylamido)M(R)₂;
μ-(CH₃)₂Si(η⁵-2,6,6-trimethyl-1,5,6,7-tetrahydro-s-indacen-1-yl)(tertbutylamido)M(R)₂;
   where M is selected from Ti, Zr, and Hf; and R is selected from halogen or C1 to C5 alkyl.

A catalyst of the present disclosure can also be a chromium or chromium-based catalyst. Chromium-based catalysts include chromium oxide (CrO3) and silylchromate catalysts. Chromium catalysts have been the subject of much development in the area of continuous fluidized-bed gas-phase polymerization for the production of polyethylene polymers. Such catalysts and polymerization processes have been described, for example, in U.S. Publication No. 2011/0010938 and U.S. Pat. Nos. 7,915,357; 8,129,484; 7,202,313; 6,833,417; 6,841,630; 6,989,344; 7,504,463; 7,563,851; 8,420,754; and 8,101,691.

In at least one embodiment, the catalyst compound having a Group 3 through Group 12 metal atom or lanthanide metal atom is a bis(phenolate) catalyst compound represented by Formula (I):

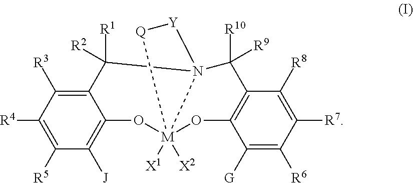

M is a Group 4 metal. X¹ and X² are independently a univalent C1-C20 hydrocarbyl, C1-C20 substituted hydrocarbyl, a heteroatom or a heteroatom-containing group, or X¹ and X² join together to form a C4-C62 cyclic or polycyclic ring structure. R¹, R², R³, R⁴, R⁵, R⁶, R⁷, R, R⁹, and R¹⁰ is independently hydrogen, C1-C40 hydrocarbyl, C1-C40 substituted hydrocarbyl, a heteroatom or a heteroatom-containing group, or two or more of R¹, R², R³, R⁴, R⁵, R⁶, R⁷, R⁸, R⁹, or R¹⁰ are joined together to form a C4-C62 cyclic or polycyclic ring structure, or a combination thereof. Q is a neutral donor group. J is heterocycle, a substituted or unsubstituted C7-C60 fused polycyclic group, where at least one ring is aromatic and where at least one ring, which may or may not be aromatic, has at least five ring atoms. G is as defined for J or may be hydrogen, C2-C60 hydrocarbyl, C1-C60 substituted hydrocarbyl, or may independently form a C4-C60 cyclic or polycyclic ring structure with R⁶, R⁷, or R⁸ or a combination thereof. Y is divalent C1-C20 hydrocarbyl or divalent C1-C20 substituted hydrocarbyl or (-Q*-Y-) together form a heterocycle. Heterocycle may be aromatic and/or may have multiple fused rings.

In at least one embodiment, the first catalyst compound represented by Formula (I) is:

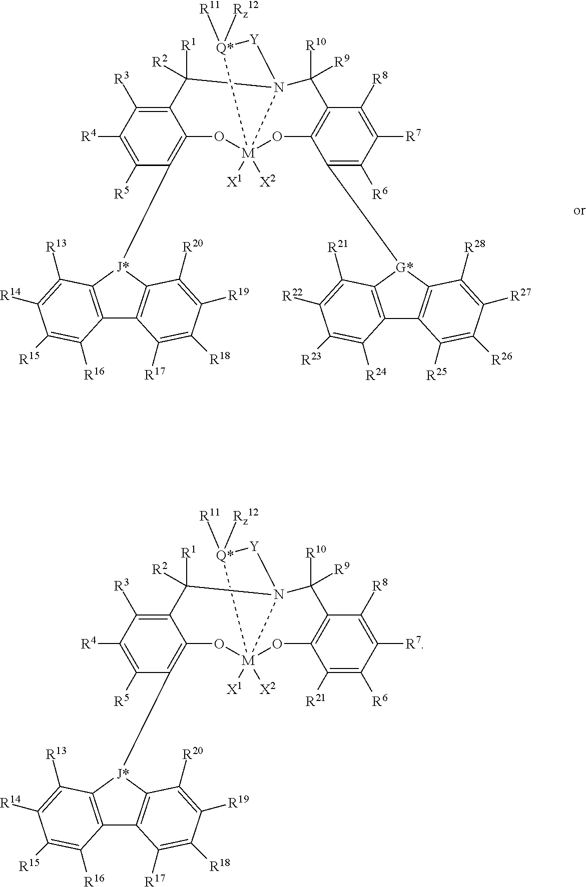

M is Hf, Zr, or Ti. X¹, X², R¹, R², R³, R⁴, R⁵, R⁶, R⁷, R⁸, R⁹, R¹⁰, and Y are as defined for Formula (I). R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ is independently a hydrogen, C1-C40 hydrocarbyl, C1-C40 substituted hydrocarbyl, a functional group comprising elements from Groups 13 to 17, or two or more of R¹, R², R³, R⁴, R⁵, R⁶, R⁷, R⁸, R⁹, R¹⁰ R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ may independently join together to form a C4-C62 cyclic or polycyclic ring structure, or a combination thereof. R¹¹ and R¹² may join together to form a five- to eight-membered heterocycle. Q* is a group 15 or 16 atom, z is 0 or 1, J* is CR″ or N, and G* is CR″ or N, where R″ is C1-C20 hydrocarbyl or carbonyl-containing C1-C20 hydrocarbyl, z=0 if Q* is a group 16 atom, and z=1 if Q* is a group 15 atom.

In at least one embodiment, the first catalyst compound represented by Formula (I) is:

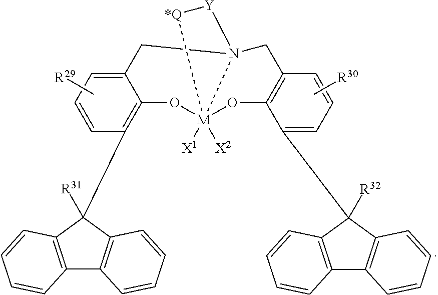

Y is a divalent C1-C3 hydrocarbyl. Q* is NR₂, OR, SR, PR₂, where R is as defined for R¹ represented by Formula (I). M is Zr, Hf, or Ti. X¹ and X² is independently as defined for Formula (I). R²⁹ and R³⁰ is independently C1-C40 hydrocarbyl. R³¹ and R³² is independently linear C1-C20 hydrocarbyl, benzyl, or tolyl.

Catalyst systems of the present disclosure may include a second catalyst compound having a chemical structure different than the first catalyst compound of the catalyst system. For purposes of the present disclosure one catalyst compound is considered different from another if they differ by at least one atom. For example “bisindenyl zirconium dichloride” is different from (indenyl)(2-methylindenyl) zirconium dichloride” which is different from “(indenyl)(2-methylindenyl) hafnium dichloride.” Catalyst compounds that differ only by isomer are considered the same for purposes of this disclosure, e.g., rac-dimethylsilylbis(2-methyl 4-phenyl)hafnium dimethyl is considered to be the same as meso-dimethylsilylbis(2-methyl 4-phenyl)hafnium dimethyl.

In at least one embodiment, two or more different catalyst compounds are present in the catalyst system used herein. In at least one embodiment, two or more different catalyst compounds are present in the reaction zone where the process(es) described herein occur. When two transition metal catalysts are used in one reactor as a mixed catalyst system, the two transition metal compounds are preferably chosen such that the two are compatible. Any suitable screening method, such as by ¹H or ¹³C NMR, can be used to determine which transition metal compounds are compatible. It is preferable to use the same activator for the transition metal compounds, however, two different activators, such as a non-coordinating anion activator and an alumoxane, can be used in combination. If one or more transition metal compounds contain an X₁ or X₂ ligand which is not a hydride, hydrocarbyl, or substituted hydrocarbyl, then the alumoxane should be contacted with the transition metal compounds prior to addition of the non-coordinating anion activator.

The first catalyst compound and the second catalyst compound may be used in any ratio (A:B). The first catalyst compound may be (A) if the second catalyst compound is (B). Alternatively, the first catalyst compound may be (B) if the second catalyst compound is (A). Preferred molar ratios of (A) transition metal compound to (B) transition metal compound fall within the range of (A:B) about 1:1000 to about 1000:1, such as from about 1:100 to about 500:1, such as from about 1:10 to about 200:1, such as from about 1:1 to about 100:1, and alternatively 1:1 to 75:1, and alternatively 5:1 to 50:1. The particular ratio chosen will depend on the exact catalysts chosen, the method of activation, and the end product desired. In a particular embodiment, when using the two catalyst compounds, where both are activated with the same activator, useful mole percents, based upon the molecular weight of the catalyst compounds, are from about 10 to about 99.9% of (A) to about 0.1 to about 90% of (B), such as from about 25 to about 99% (A) to about 0.5 to about 50% (B), such as from about 50 to about 99% (A) to about 1 to about 25% (B), such as from about 75 to about 99% (A) to about 1 to about 10% (B).

### Processes for Preparing Catalysts

### Bis(Phenolate) Catalyst Compounds

Bis(phenolate) catalyst compounds: In an embodiment of the present disclosure (as shown in Scheme 1), the bis(phenolate) transition metal compounds may be prepared by two general synthetic routes. In an embodiment of the present disclosure, the amine bis(phenolate) ligands may be prepared by a one-step Mannich reaction from the parent phenol (Reaction A) or by a nucleophilic substitution reaction of the methylbromide derivative of the phenol (Reaction B). The ligand is then typically reacted with the metal tetra-alkyl compound, e.g., tetrabenzyl, to yield the metal dibenzyl complex of the ligand (Reaction C).

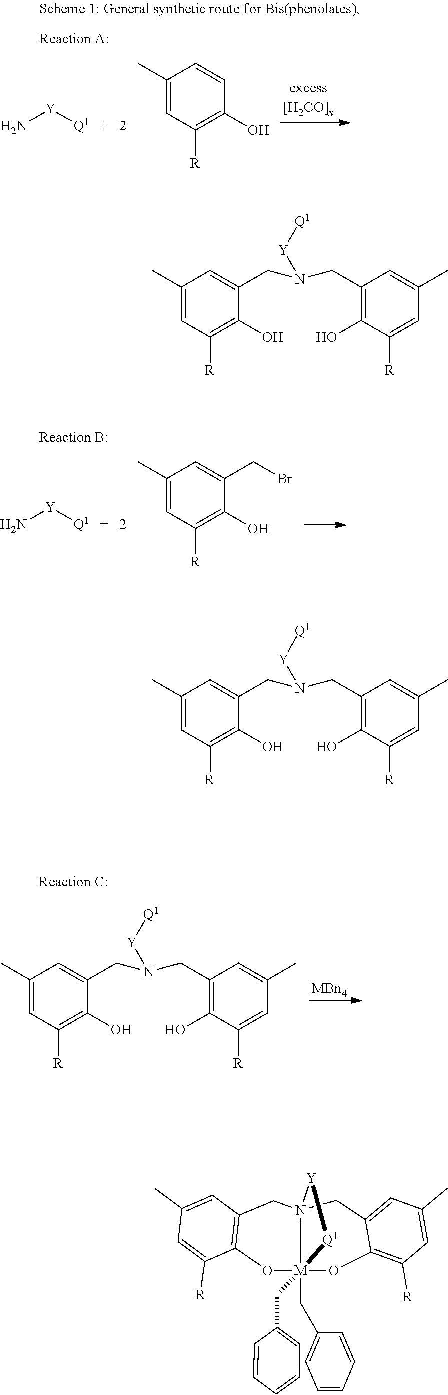

M, Y, and Q¹ are as defined for M, Y, and Q above, [H₂CO]ₓ is paraformaldehyde, Bn is benzyl, and each R is, independently, as defined for G or J above, provided that at least one R is as defined for J.

### Metallocene Catalyst Compounds

Silyl-bridged cyclopentadienyl ligands R′₂Si(n-PrCpH)₂ (where R′=Me, Ph) have been synthesized quantitatively by direct salt metathesis reaction between R′₂SiCl₂ and two equivalents of lithium-n-propyl-cyclopentadienide in tetrahydrofuran solvent at ambient temperature (Scheme 2). The synthesized neutral ligands are conveniently deprotonated with n-butyl lithium at −25° C. The absence of cyclopentadienyl protons between δ=3.2 ppm and δ=3.6 ppm in ¹H NMR spectra further supports the lithium salt formation. The salt elimination route has been adopted to synthesis corresponding hafnocene dichloride by an equimolar ratio of the above lithium salt of cyclopentadienide ligands with hafnium tetrachloride. Further, treatment of silyl-bridged cyclopentadienide hafnium dichloride with two equivalents of methyl magnesium bromide under milder reaction conditions afforded a pale yellow Me₂Si(n-propylCp)₂HfMe₂ and Ph₂Si(n-proylCp)₂HfMe₂ metallocene catalyst compounds in good yield. Catalyst precursors and hafnocene catalyst compounds structures were confirmed by ¹H NMR spectroscopy.

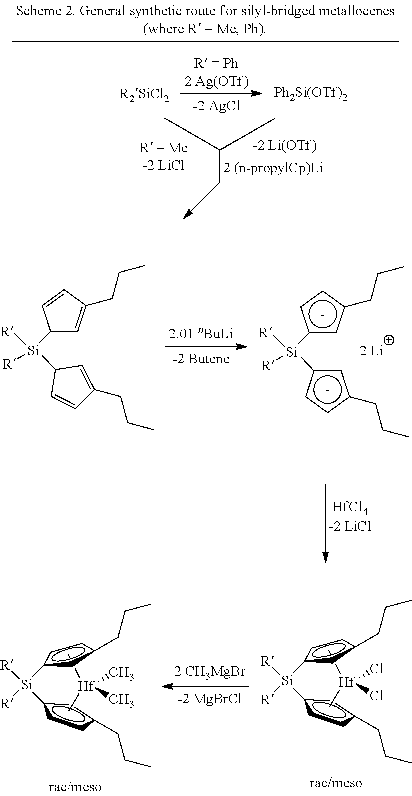

### Activators

Catalyst systems of the present disclosure can include at least one activator. The activator can be an alkylalumoxane, such as methylalumoxane.

Conventional catalyst systems often contain a molar ratio of metal to catalyst compound metal of greater than 100:1. It has been discovered that a catalyst system having a support material composition having a macroporosity from about 0.15 cc/g to about 0.5 cc/g provides catalyst system compositions having reduced activator content, as compared to conventional catalyst systems. For example, an activator, such as an alkylalumoxane, can be present in a catalyst system of the present disclosure at a molar ratio of metal (such as aluminum) to catalyst compound metal of about 100:1 or less, such as about 50:1 or less. Alternatively, a molar ratio of metal (such as aluminum) to catalyst compound metal is from about 50:1 to about 200:1, such as about 100:1.

The catalyst systems may be formed by combining the above catalysts with activators in any suitable manner including by supporting them for use in slurry or gas phase polymerization. Activators are defined to be any compound which can activate any one of the catalyst compounds described above by converting the neutral metal compound to a catalytically active metal compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract a reactive, σ-bound, metal ligand making the metal compound cationic and providing a charge-balancing noncoordinating or weakly coordinating anion.

In at least one embodiment, the activator is represented by the formula: (Z)_{d}⁺(A^{d-}). Z is (L−H) or a reducible Lewis Acid, L is an neutral Lewis base, and H is hydrogen. (L−H)⁺ is a Bronsted acid. A^{d-} is a non-coordinating anion having the charge d- and d is an integer from 1 to 3. In at least one embodiment, Z is a reducible Lewis acid represented by the formula: (Ar₃C⁺), where Ar is aryl or aryl substituted with a heteroatom, a C1 to C40 hydrocarbyl, or a substituted C1 to C40 hydrocarbyl.

### Alumoxane Activators

Alumoxane activators are utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under U.S. Pat. No. 5,041,584).

When the activator is an alumoxane (modified or unmodified), some embodiments select the maximum amount of activator typically at up to a 5000-fold molar excess Al/M over the catalyst compound (per metal catalytic site). The minimum activator-to-catalyst-compound is a 1:1 molar ratio. Alternate ranges include from 1:1 to 500:1, alternately from 1:1 to 200:1, alternately from 1:1 to 100:1, or alternately from 1:1 to 50:1.

In an alternative embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

### Ionizing/Non Coordinating Anion Activators

The term “non-coordinating anion” (NCA) means an anion which either does not coordinate to a cation or which is only weakly coordinated to a cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Ionizing activators useful herein typically comprise an NCA, particularly a compatible NCA.

It is within the scope of the present disclosure to use an ionizing activator, neutral or ionic, such as tri (n-butyl) ammonium tetrakis (pentafluorophenyl) borate, a tris perfluorophenyl boron metalloid precursor or a tris perfluoronaphthyl boron metalloid precursor, polyhalogenated heteroborane anions (WO 98/43983), boric acid (U.S. Pat. No. 5,942,459), or combination thereof. It is also within the scope of the present disclosure to use neutral or ionic activators alone or in combination with alumoxane or modified alumoxane activators. For descriptions of useful activators please see U.S. Pat. Nos. 8,658,556 and 6,211,105.

### Polymerization Processes

It has also been discovered that a catalyst system having a support material composition having a macroporosity from about 0.15 cc/g to about 0.50 cc/g provides reduced sheeting and chunking within a reactor during polymerization.

Sheeting and/or chunking during polymerization can be monitored by the temperature of the wall (measured with a thermocouple either on or just penetrating the reactor wall, known as a “skin TC”) within a reactor. When polymer granules lose mobility near the reactor wall, the reactor is in danger of sheeting or chunking. Skin temperature can decrease, as monitored by a thermocouple on or within the reactor, because a solid insulating layer of polymer is formed on the walls of the reactor. This decrease in temperature of the skin is typically referred to as a “cold-band”. Without being bound by theory, cold-bands form when non-reactive granules are suspended near the wall by a dangerous level of static charges. If sheets form on the walls of the reactor, the reactor is typically shut down and cleaned, which increases polymer formation time and financial cost.

An increase in reactor skin temperature is also possible. An increase in reactor skin temperature is known as a positive skin thermocouple deviation. These deviations are typically the result of these same static charges immobilizing reacting granules, which heat above their melting point due to the exothermic polymerization reaction, then stick together to form sheets or chunks. Eventually a solid strip of polymer, called a “sheet,” is formed and dislodged to the main body of the reactor resulting in a decrease in operability. In many cases, several hours to days of a reactor shut down are involved to remove the sheets before restarting the polymerization process.

Embodiments of the present disclosure reduce or eliminate cold-bands and/or positive skin thermocouple deviations during polyolefin polymerization thereby reducing or eliminating the occurrence of sheeting and/or chunking within the reactor.

In at least one embodiment of the present disclosure, a process includes polymerizing olefins to produce a polyolefin composition by contacting at least one olefin with a catalyst system of the present disclosure and obtaining the polyolefin composition. Polymerization may be conducted at a temperature of from about 0° C. to about 300° C., at a pressure in the range of from about 0.35 MPa to about 10 MPa, and/or at a time up to about 300 minutes.

Embodiments of the present disclosure include polymerization processes where monomer (such as ethylene or propylene), and optionally comonomer, are contacted with a catalyst system comprising at least one catalyst compound and an activator, as described above. The at least one catalyst compound and activator may be combined in any order, and are combined typically prior to contact with the monomer.

Monomers useful herein include substituted or unsubstituted C2 to C40 alpha olefins, preferably C2 to C20 alpha olefins, preferably C2 to C12 alpha olefins, preferably ethylene, propylene, butene, pentene, hexene, heptene, octene, nonene, decene, undecene, dodecene and isomers thereof. In a preferred embodiment, olefins include a monomer that is propylene and one or more optional comonomers comprising one or more ethylene or C4 to C40 olefin, preferably C4 to C20 olefin, or preferably C6 to C12 olefin. The C4 to C40 olefin monomers may be linear, branched, or cyclic. The C4 to C40 cyclic olefin may be strained or unstrained, monocyclic or polycyclic, and may include one or more heteroatoms and/or one or more functional groups. In another preferred embodiment, olefins include a monomer that is ethylene and an optional comonomer comprising one or more of C3 to C40 olefin, preferably C4 to C20 olefin, or preferably C6 to C12 olefin. The C3 to C40 olefin monomers may be linear, branched, or cyclic. The C3 to C40 cyclic olefins may be strained or unstrained, monocyclic or polycyclic, and may include heteroatoms and/or one or more functional groups.

Exemplary C2 to C40 olefin monomers and optional comonomers include ethylene, propylene, butene, pentene, hexene, heptene, octene, nonene, decene, undecene, dodecene, norbornene, norbomadiene, dicyclopentadiene, cyclopentene, cycloheptene, cyclooctene, cyclooctadiene, cyclododecene, 7-oxanorbomene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and substituted derivatives thereof, preferably norbornene, norbomadiene, and dicyclopentadiene.

In at least one embodiment, one or more dienes are present in a polymer produced herein at up to about 10 weight %, such as from about 0.00001 to about 1.0 weight %, such as from about 0.002 to about 0.5 weight %, such as from about 0.003 to about 0.2 weight %, based upon the total weight of the composition. In at least one embodiment, about 500 ppm or less of diene is added to the polymerization, such as about 400 ppm or less, such as about 300 ppm or less. In at least one embodiment, at least about 50 ppm of diene is added to the polymerization, or about 100 ppm or more, or 150 ppm or more.

Diolefin monomers include any hydrocarbon structure, preferably C4 to C30, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers). In at least one embodiment, the diolefin monomers are linear di-vinyl monomers, such as those containing from 4 to 30 carbon atoms. Non-limiting examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Non-limiting example cyclic dienes include cyclopentadiene, vinylnorbornene, norbornadiene, ethylidene norbornene, divinylbenzene, dicyclopentadiene or higher ring containing diolefins with or without substituents at various ring positions.

In at least one embodiment, where butene is the comonomer, the butene source may be a mixed butene stream comprising various isomers of butene. The 1-butene monomers are expected to be preferentially consumed by the polymerization process as compared to other butene monomers. Use of such mixed butene streams will provide an economic benefit, as these mixed streams are often waste streams from refining processes, for example, C4 raffinate streams, and can therefore be substantially less expensive than pure 1-butene.

Polymerization processes of the present disclosure can be carried out in any suitable manner. Any suitable suspension, homogeneous, bulk, solution, slurry, and/or gas phase polymerization process can be used. Such processes can be run in a batch, semi-batch, or continuous mode. Homogeneous polymerization processes and slurry processes are preferred in some embodiments. (A homogeneous polymerization process is defined to be a process where at least about 90 wt % of the product is soluble in the reaction media.) A bulk homogeneous process is particularly preferred. (A bulk process is defined to be a process where monomer concentration in all feeds to the reactor is 70 volume % or more.) Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process. As used herein, the term “slurry polymerization process” means a polymerization process where a supported catalyst is used and monomers are polymerized on the supported catalyst particles. At least 95 wt % of polymer products derived from the supported catalyst are in granular form as solid particles (not dissolved in the diluent). Processes of the present disclosure may include introducing the catalyst system into a reactor as a slurry.

Suitable diluents/solvents for polymerization include non-coordinating, inert liquids. Non-limiting examples include straight and branched-chain hydrocarbons, such as isobutane, butane, pentane, isopentane, hexane, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C4 to C10 alkanes, chlorobenzene, and aromatic and alkylsubstituted aromatic compounds, such as benzene, toluene, mesitylene, and xylene. Suitable solvents also include liquid olefins which may act as monomers or comonomers including, but not limited to, ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexane, isohexane, heptane, octane, dodecane, or mixtures thereof; cyclic and alicyclic hydrocarbons, such as cyclohexane, cycloheptane, methylcyclohexane, methylcycloheptane, or mixtures thereof. In another embodiment, the solvent is not aromatic, and aromatics are present in the solvent at less than about 1 wt %, such as less than about 0.5 wt %, such as about 0 wt % based upon the weight of the solvents.

In at least one embodiment, the feed concentration of the monomers and comonomers for the polymerization is about 60 vol % solvent or less, preferably about 40 vol % or less, or about 20 vol % or less, based on the total volume of the feedstream. Preferably the polymerization is run in a bulk process.

Preferred polymerizations can be run at any temperature and/or pressure suitable to obtain the desired polyolefins. Typical temperatures and/or pressures include a temperature from about 0° C. to about 300° C., such as from about 20° C. to about 200° C., such as from about 35° C. to about 150° C., such as from about 40° C. to about 120° C., such as from about 65° C. to about 95° C.; and at a pressure from about 0.35 MPa to about 10 MPa, such as from about 0.45 MPa to about 6 MPa, or preferably from about 0.5 MPa to about 4 MPa.

In a typical polymerization, the run time of the reaction is up to about 300 minutes, such as from about 5 to about 250 minutes, such as from about 30 to about 200 minutes.

Hydrogen, may be added to a reactor for molecular weight control of polyolefins. In at least one embodiment, hydrogen is present in the polymerization reactor at a partial pressure of from about 0.001 and 50 psig (0.007 to 345 kPa), such as from about 0.01 to about 25 psig (0.07 to 172 kPa), such as from about 0.1 and 10 psig (0.7 to 70 kPa). In one embodiment, 1500 ppm or less of hydrogen is added, or 1000 ppm or less of hydrogen is added, or 400 ppm or less or 300 ppm or less. In other embodiments, at least 50 ppm of hydrogen is added, or 100 ppm or more, or 150 ppm or more.

In an alternative embodiment, the activity of the catalyst is at least about 50 g/mmol/hour, such as about 500 or more g/mmol/hour, such as about 5,000 or more g/mmol/hr, such as about 50,000 or more g/mmol/hr. In an alternative embodiment, the conversion of olefin monomer is at least about 10%, based upon polymer yield (weight) and the weight of the monomer entering the reaction zone, such as about 20% or more, such as about 30% or more, such as about 50% or more, such as about 80% or more.

Space time yield (STY) is the weight of polymer produced per hour of reaction per unit volume of reactor. In at least one embodiment, the space time yield is about 10 lb/hr/ft³ or greater, such as about 12 lb/hr/ft³ or greater, such as about 14 lb/hr/ft³ or greater.

In at least one embodiment, little or no alumoxane is used in the process to produce the polymers. Preferably, alumoxane is present at zero mol %. Alternatively, the alumoxane is present at a molar ratio of aluminum to transition metal of a catalyst compound of less than about 500:1, such as less than about 300:1, such as less than about 100:1, such as less than about 1:1.

In a preferred embodiment, little or no scavenger is used in the process to produce the polyolefin composition. Scavenger (such as tri alkyl aluminum) can be present at zero mol %. Alternatively, the scavenger is present at a molar ratio of scavenger metal to transition metal of the catalyst of less than about 100:1, such as less than about 50:1, such as less than about 15:1, such as less than about 10:1.

In at least one embodiment, the polymerization: 1) is conducted at temperatures of 0 to 300° C. (preferably 25 to 150° C., preferably 40 to 120° C., preferably 65 to 95° C.); 2) is conducted at a pressure of atmospheric pressure to 10 MPa (preferably 0.35 to 10 MPa, preferably from 0.45 to 6 MPa, preferably from 0.5 to 4 MPa); 3) is conducted in an aliphatic hydrocarbon solvent (such as isobutane, butane, pentane, isopentane, hexanes, isohexane, heptane, octane, dodecane, and mixtures thereof; cyclic or alicyclic hydrocarbons, such as cyclohexane, cycloheptane, methylcyclohexane, methylcycloheptane, or mixtures thereof; preferably where aromatics are present in the solvent at less than 1 wt %, preferably less than 0.5 wt %, preferably at 0 wt % based upon the weight of the solvents); 4) wherein the catalyst system used in the polymerization comprises less than 0.5 mol % alumoxane, preferably 0 mol % alumoxane. Alternatively, the alumoxane is present at a molar ratio of aluminum to transition metal of a catalyst compound of less than 500:1, preferably less than 300:1, preferably less than 100:1, preferably less than 1:1; 5) the polymerization preferably occurs in one reaction zone; 6) the productivity of the catalyst compound is at least 80,000 g/mmol/hr (preferably at least 150,000 g/mmol/hr, preferably at least 200,000 g/mmol/hr, preferably at least 250,000 g/mmol/hr, preferably at least 300,000 g/mmol/hr); 7) optionally scavengers (such as trialkyl aluminum compounds) are absent (e.g., present at zero mol %). Alternatively, the scavenger is present at a molar ratio of scavenger metal to transition metal of less than 100:1, preferably less than 50:1, preferably less than 15:1, preferably less than 10:1; and 8) optionally hydrogen is present in the polymerization reactor at a partial pressure of 0.001 to 50 psig (0.007 to 345 kPa) (preferably from 0.01 to 25 psig (0.07 to 172 kPa), more preferably 0.1 to 10 psig (0.7 to 70 kPa)). In a preferred embodiment, the catalyst system used in the polymerization comprises no more than one catalyst compound. A “reaction zone”, also referred to as a “polymerization zone”, is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone.

Other additives may also be used in the polymerization, as desired, such as one or more scavengers, promoters, modifiers, chain transfer agents (such as diethyl zinc), reducing agents, oxidizing agents, hydrogen, aluminum alkyls, or silanes.

Chain transfer agents may be alkylalumoxanes, a compound represented by the formula AlR₃, ZnR₂ (where each R is, independently, a C₁-C₈ aliphatic radical, preferably methyl, ethyl, propyl, butyl, penyl, hexyl, heptyl, octyl or an isomer thereof) or a combination thereof, such as diethyl zinc, methylalumoxane, trimethylaluminum, triisobutylaluminum, trioctylaluminum, or a combination thereof.

### Polyolefin Products

The present disclosure also relates to polyolefin compositions, such as resins, produced by the catalyst systems and/or processes of the present disclosure.

In at least one embodiment, a process includes utilizing a catalyst system of the present disclosure to produce propylene homopolymers or propylene copolymers, such as propylene-ethylene and/or propylene-alphaolefin (preferably C3 to C20) copolymers (such as propylene-hexene copolymers or propylene-octene copolymers) having an Mw/Mn of greater than about 1, such as greater than about 2, such as greater than about 3, such as greater than about 4.

In at least one embodiment, a process includes utilizing a catalyst system of the present disclosure to produce olefin polymers, preferably polyethylene and polypropylene homopolymers and copolymers. In at least one embodiment, the polymers produced herein are homopolymers of ethylene or copolymers of ethylene preferably having from about 0 and 25 mole % of one or more C3 to C20 olefin comonomer (such as from about 0.5 and 20 mole %, such as from about 1 to about 15 mole %, such as from about 3 to about 10 mole %). Olefin comonomers may be C3 to C12 alpha-olefins, such as one or more of propylene, butene, hexene, octene, decene, or dodecene, preferably propylene, butene, hexene, or octene. Olefin monomers may be one or more of ethylene or C4 to C12 alpha-olefin, preferably ethylene, butene, hexene, octene, decene, or dodecene, preferably ethylene, butene, hexene, or octene.

Polymers produced herein may have an Mw of from about 5,000 to about 1,000,000 g/mol (such as from about 25,000 to about 750,000 g/mol, such as from about 50,000 to about 500,000 g/mol), and/or an Mw/Mn of from about 1 to about 40 (such as from about 1.2 to about 20, such as from about 1.3 to about 10, such as from about 1.4 to about 5, such as from about 1.5 to about 4, such as from about 1.5 to about 3). Polymers produced herein may have a Melt Index (MI) of from 0.05 to about 1, such as about 0.5 or less, such as about 0.4 or less, such as about 0.3 or less, for example 0.28 or less. MI, also referred to as I₂, is reported in dg/min and can be determined according to ASTM D1238, 190° C., 2.16 kg load. Polymers produced herein can have a density from about 0.92 g/cm³ to about 0.96 g/cm³, such as from about 0.93 g/cm³ to about 0.95 g/cm³, such as about 0.94 g/cm³, for example 0.937 g/cm³ or greater.

In an embodiment, the polymer produced herein has a multimodal molecular weight distribution as determined by Gel Permeation Chromotography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versa).

In a preferred embodiment, the polymer produced herein has a composition distribution breadth index (CDBI) of 50% or more, preferably 60% or more, preferably 70% or more. CDBI is a measure of the composition distribution of monomer within the polymer chains and is measured by the procedure described in PCT publication WO 93/03093, published Feb. 18, 1993, specifically columns 7 and 8 as well as in Wild et al., J. Poly. Sci., Poly. Phys. Ed., Vol. 20, p. 441 (1982) and U.S. Pat. No. 5,008,204, including those fractions having a weight average molecular weight (Mw) below 15,000 are ignored when determining CDBI.

In another embodiment, the polymer produced herein has two peaks in the TREF measurement. Two peaks in the TREF measurement as used herein means the presence of two distinct normalized ELS (evaporation mass light scattering) response peaks in a graph of normalized ELS response (vertical or y axis) versus elution temperature (horizontal or x axis with temperature increasing from left to right) using the TREF method below. A “peak” in this context means where the general slope of the graph changes from positive to negative with increasing temperature. Between the two peaks is a local minimum in which the general slope of the graph changes from negative to positive with increasing temperature. “General trend” of the graph is intended to exclude the multiple local minimums and maximums that can occur in intervals of 2° C. or less. Preferably, the two distinct peaks are at least 3° C. apart, more preferably at least 4° C. apart, even more preferably at least 5° C. apart. Additionally, both of the distinct peaks occur at a temperature on the graph above 20° C. and below 120° C. where the elution temperature is run to 0° C. or lower. This limitation avoids confusion with the apparent peak on the graph at low temperature caused by material that remains soluble at the lowest elution temperature. Two peaks on such a graph indicate a bi-modal composition distribution (CD). TREF analysis is done using a CRYSTAF-TREF 200+ instrument from Polymer Char, S.A., Valencia, Spain. The principles of TREF analysis and a general description of the particular apparatus to be used are given in the article Monrabal, B.; del Hierro, P. Anal. Bioanal. Chem. Vol. 399, 1557 (2011). An alternate method for TREF measurement can be used if the method above does not show two peaks, i.e., see B. Monrabal, “Crystallization Analysis Fractionation: A New Technique for the Analysis of Branching Distribution in Polyolefins,” Journal of Applied Polymer Science, Vol. 52, 491-499 (1994).

### Blends

In at least one embodiment, the polymer (such as polyethylene or polypropylene) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In at least one embodiment, the polymer (such as polyethylene or polypropylene) is present in the above blends, at from about 10 to about 99 wt %, based upon the weight of total polymers in the blend, such as from about 20 to about 95 wt %, such as from about 30 to about 90 wt %, such as from about 40 to about 90 wt %, such as from about 50 to about 90 wt %, such as from about 60 to about 90 wt %, such as from about 70 to about 90 wt %.

Blends of the present disclosure may be produced by mixing the polymers of the present disclosure with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

Blends of the present disclosure may be formed using conventional equipment and methods, such as by dry blending the individual components, such as polymers, and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; mixtures thereof, and the like.

In at least one embodiment, a polyolefin composition, such as a resin, that is a multimodal polyolefin composition comprises a low molecular weight fraction and/or a high molecular weight fraction. In at least one embodiment, the high molecular weight fraction is produced by the catalyst compound represented by Formula (I). The low molecular weight fraction may be produced by a second catalyst compound that is a bridged or unbridged metallocene catalyst compound, as described above. The high molecular weight fraction may be polypropylene, polyethylene, and copolymers thereof. The low molecular weight fraction may be polypropylene, polyethylene, and copolymers thereof.

In at least one embodiment, the polyolefin composition produced by a catalyst system of the present disclosure has a comonomer content from about 3 wt % to about 15 wt %, such as from about 4 wt % and bout 10 wt %, such as from about 5 wt % to about 8 wt %. In at least one embodiment, the polyolefin composition produced by a catalyst system of the present disclosure has a polydispersity index of from about 2 to about 6, such as from about 2 to about 5.

### Films

Any of the foregoing polymers, such as the foregoing polyethylenes or blends thereof, may be used in a variety of end-use applications. Such applications include, for example, mono- or multi-layer blown, extruded, and/or shrink films. These films may be formed by any suitable extrusion or coextrusion techniques, such as a blown bubble film processing technique, where the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble process and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, preferably between 5 and 7, and in the Transverse Direction (TD) at a ratio of up to 15, preferably 7 to 9. However, in another embodiment, the film is oriented to the same extent in both the MD and TD directions.

The films may vary in thickness depending on the intended application; however, films of a thickness from 1 m to 50 m may be suitable. Films intended for packaging are usually from 10 μm to 50 μm thick. The thickness of the sealing layer is typically 0.2 μm to 50 μm. There may be a sealing layer on both the inner and outer surfaces of the film or the sealing layer may be present on only the inner or the outer surface.

In another embodiment, one or more layers may be modified by corona treatment, electron beam irradiation, gamma irradiation, flame treatment, or microwave. In a preferred embodiment, one or both of the surface layers is modified by corona treatment.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

The following abbreviations may be used below: (eq. means equivalents). Melt index (MI), also referred to as I₂, reported in dg/min, is determined according to ASTM D1238, 190° C., 2.16 kg load.

High load melt index (HLMI) also referred to as I₂₁, reported in dg/min, is determined according to ASTM D1238, 190° C., 21.6 kg load.

Melt index ratio (MIR) is I₂₁/I₂.

All reagents were obtained from Sigma Aldrich (St. Louis, Mo.) and used as obtained, unless stated otherwise. All solvents were anhydrous. All reactions were performed under an inert nitrogen atmosphere, unless otherwise stated. All deuterated solvents were obtained from Cambridge Isotopes (Cambridge, Mass.) and dried over 3 Angstrom molecular sieves before use.

All molecular weights are weight average unless otherwise noted. All molecular weights are reported in g/mol unless otherwise noted.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol. Molecular weight distribution (“MWD”) is equivalent to the expression M_{w}/Mₙ. The expression M_{w}/Mₙ is the ratio of the weight average molecular weight (M_{w}) to the number average molecular weight (Mₙ).

The distribution and the moments of molecular weight (Mw, Mn, Mw/Mn, etc.), the comonomer content (C2, C3, C6, etc.) and the long chain branching (g′) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1 μm Teflon filter and degassed with an online degasser before entering the GPC instrument. The nominal flow rate is 1.0 mL/min and the nominal injection volume is 200 μL. The whole system including transfer lines, columns, detectors are contained in an oven maintained at 145° C. A given amount of polymer sample is weighed and sealed in a standard vial with 80 μL flow marker (Heptane) added to it. After loading the vial in the autosampler, polymer is automatically dissolved in the instrument with 8 mL added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples.

The concentration (c), at each point in the chromatogram is calculated from the baseline-subtracted IR5 broadband signal intensity (I), using the following equation:

c=βI

where β is the mass constant determined with PE or PP standards. The mass recovery is calculated from the ratio of the integrated area of the concentration chromatography over elution volume and the injection mass which is equal to the pre-determined concentration multiplied by injection loop volume.

The conventional molecular weight (IR MW) is determined by combining universal calibration relationship with the column calibration which is performed with a series of monodispersed polystyrene (PS) standards ranging from 700 to 10 M. The MW at each elution volume is calculated with following equation.

$$log M = \frac{log ( {K}_{PS} / K )}{a + 1} + \frac{{a}_{PS} + 1}{a + 1} log {M}_{PS}$$

where the variables with subscript “PS” stands for polystyrene while those without a subscript are for the test samples. In this method, a_{PS}=0.67 and K_{PS}=0.000175 while a and K are calculated from a series of empirical formula established in ExxonMobil and published in literature (T. Sun, P. Brant, R. R. Chance, and W. W. Graessley, Macromolecules, Vol. 34, Number 19, pp. 6812-6820, (2001)). Specifically, a/K=0.695/0.000579 for PE and 0.705/0.0002288 for PP.

The comonomer composition is determined by the ratio of the IR5 detector intensity corresponding to CH₂ and CH₃ channel calibrated with a series of PE and PP homo/copolymer standards whose nominal value are predetermined by NMR or FTIR such as EMCC commercial grades about LLDPE.

The LS detector is the 18-angle Wyatt Technology High Temperature DAWN HELEOSII. The LS molecular weight (M) at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A₂ is the second virial coefficient. P(θ) is the form factor for a monodisperse random coil, and K_{O} is the optical constant for the system:

$${K}_{o} = \frac{4 {π}^{2} {{n}^{2} ( dn / d c )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the following equation:

[η]=η_{S}/c

where c is concentration and was determined from the IR5 broadband channel output. The viscosity MW at each point is calculated from the below equation:

M=K_{PS}M^{a}^{_{PS}}⁺¹/[η].

The branching index (g′_{VIS}) is calculated using the output of the GPC-DRI-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′ᵥᵢₛ is defined as:

$${g}^{′} vis = \frac{{[ η ]}_{avg}}{{kM}_{v}^{α}}$$

M_{V} is the viscosity-average molecular weight based on molecular weights determined by LS analysis. Z average branching index (g′zₐᵥₑ) is calculated using Ci=polymer concentration in the slice i in the polymer peak times the mass of the slice squared, Mi².

All molecular weights are weight average unless otherwise noted. All molecular weights are reported in g/mol unless otherwise noted.

### Supported Catalysts

### Support A1

A solution of 1300 mL of 30 wt % alumoxane (MAO) (purchased from Albemarle Labs) (in toluene as determined by reference to the total A1 content) was charged to a two gallon (7.57 L), jacketed glass-walled reactor, equipped with a helical ribbon blender and an auger-type shaft. 2080 mL of toluene was added and stirred. A suspension of 31.5 g of XCAT™ EZ-100 Metallocene Catalyst available from Univation Technologies, LLC, Houston, Tex.) in 320 mL of toluene (purchased from Albemarle Labs), was cannulated to the reactor. An additional bottle of dry toluene (250 mL) was used to rinse solid metallocene crystals into the reactor by cannula under nitrogen pressure. A color change from colorless to yellow/orange was noted upon addition of the metallocene to the MAO solution. The mixture was allowed to stir at 69° F. (20.6° C.) for one hour, before being transferred to a four-liter Erlenmeyer flask under nitrogen. Silica A1, 1040 g, (as described below) was charged to the reactor. Half of the solution from the 4 L Erlenmeyer flask was then transferred back to the 2 gallon (7.57 L) stirred glass reactor. The reaction temperature rose from 70° F. (21.1° C.) to 100° F. (37.8° C.) in a five minute exotherm. The balance of the solution in the 4 L Erlenmeyer flask was subsequently added back to the glass reactor, and stirred twenty minutes. Then, toluene was added (273 mL, 238 g) to dilute the active catalyst slurry, and stirred an additional twenty-five minutes. Antistat AS-990, a surface modifier made from ethoxylated stearylamine sold by Witco Chemical Corp. or Evonik (sold as Varonic S-202) (7 g in 73 mL toluene) was cannulated to the reactor and the slurry mixed for thirty minutes. Removal of solvent commenced by reducing pressure to less than 18 inches of mercury (457 mmHg) while feeding a small stream of nitrogen into the bottom of the reactor and raising the temperature from 74° F. (23.3° C.) to 142° F. (61.1° C.) over a period of one hour. Then, five additional hours of drying at 142° F. (61.1° C.) to 152° F. (66.7° C.) and vacuum which ranged from 5 inches to 22 inches Hg (127 to 559 mmHg) were used to dry the support and yield 1709.0 g of free-flowing active supported catalyst material.

### Support A2:

A solution of 1300 mL of 30 wt % alumoxane (MAO) in toluene as determined by reference to the total A1 content was charged to a two gallon (7.57 L), jacketed glass-walled reactor, equipped with a helical ribbon blender and an auger-type shaft. 2080 mL of toluene was added and stirred. A suspension of 31.5 g of XCAT™ EZ-100 Metallocene Catalyst (available from Univation Technologies, LLC, Houston, Tex.) in 320 mL of toluene (purchased from Albemarle Labs) was cannulated to the reactor. An additional bottle of dry toluene (250 mL) was used to rinse solid metallocene crystals into the reactor by cannula under nitrogen pressure. A color change from colorless to yellow/orange was noted upon addition of the metallocene to the MAO solution. The mixture was allowed to stir at 69° F. (20.6° C.) for one hour, before being transferred to a four-liter Erlenmeyer flask under nitrogen. Silica A2, 1040 g, (as described below) was charged to the reactor. Half of the solution from the 4 L Erlenmeyer flask was then transferred back to the 2 gallon (7.57 L) stirred glass reactor. The reaction temperature rose from 70° F. (21.1° C.) to 100° F. (37.8° C.) in a five minute exotherm. The balance of the solution in the 4 L Erlenmeyer flask was subsequently added back to the glass reactor and stirred twenty minutes. Then, toluene was added (273 mL, 238 g) to dilute the active catalyst slurry, and stirred an additional twenty-five minutes. Antistat AS-990 (7 g in 73 mL toluene) was cannulated to the reactor and the slurry mixed for thirty minutes. Removal of solvent commenced by reducing pressure to less than 18 inches of mercury (457 mmHg) while feeding a small stream of nitrogen into the bottom of the reactor and raising the temperature from 74° F. (23.3° C.) to 142° F. (61.1° C.) over a period of one hour. Then, five additional hours of drying at 142° F. (61.1° C.) to 152° F. (66.7° C.) and vacuum which ranged from 5 inches to 22 inches Hg (127 to 559 mmHg) were used to dry the support and yield 1709.0 g of free-flowing active supported catalyst material.

### Support A3:

A solution of 1300 mL of 30 wt % alumoxane (MAO) in toluene as determined by reference to the total A1 content was charged to a two gallon (7.57 L), jacketed glass-walled reactor, equipped with a helical ribbon blender and an auger-type shaft. 2080 mL of toluene was added and stirred. A suspension of 31.5 g of XCAT™ EZ-100 Metallocene Catalyst in 320 mL of toluene (purchased from Albemarle Labs) was cannulated to the reactor. An additional bottle of dry toluene (250 mL) was used to rinse solid metallocene crystals into the reactor by cannula under nitrogen pressure. A color change from colorless to yellow/orange was noted upon addition of the metallocene to the MAO solution. The mixture was allowed to stir at 69° F. (20.6° C.) for one hour, before being transferred to a four-liter Erlenmeyer flask under nitrogen. Silica A3, 1040 g, (as described below) was charged to the reactor. Half of the solution from the 4 L Erlenmeyer flask was then transferred back to the 2 gallon (7.57 L) stirred glass reactor. The reaction temperature rose from 70° F. (21.1° C.) to 100° F. (37.8° C.) in a five minute exotherm. The balance of the solution in the 4 L Erlenmeyer flask was subsequently added back to the glass reactor, and stirred twenty minutes. Then, toluene was added (273 mL, 238 g) to dilute the active catalyst slurry, and stirred an additional twenty-five minutes. Antistat AS-990 was cannulated to the reactor and the slurry mixed for thirty minutes. Removal of solvent commenced by reducing pressure to less than 18 inches of mercury (457 mmHg) while feeding a small stream of nitrogen into the bottom of the reactor and raising the temperature from 74° F. (23.3° C.) to 142° F. (61.1° C.) over a period of one hour. Then, five additional hours of drying at 142° F. (61.1° C.) to 152° F. (66.7° C.) and vacuum which ranged from 5 inches to 22 inches Hg (127 to 559 mmHg) were used to dry the support and yield 1709.0 g of free-flowing active supported catalyst material.

Catalyst supports A1, A2, and A3 have the same surface area and pore volume. However, as shown in Table 1 below, A1, A2, and A3 differ in macroporosity. Macroporosity was determined using a Mercury Intrusion Test.

TABLE 1

| | Particle size determined | | | |
|---|---|---|---|---|
| | by Malvern 2000, μm | | | Macro porosity, |
| Silica | D10 | D50 | D90 | (cc/g) |
| A1 | 10 | 37 | 76 | 0.248 |
| A2 | 22 | 51 | 91 | 0.253 |
| A3 | 15 | 43 | 80 | 0.137 |

Table 2 illustrates metal distribution of the catalyst systems containing A1, A2, and A3, as determined by X-Ray Photoelectron Spectroscopy. As shown in Table 2, a support macroporosity above 0.15 cc/g provides catalyst systems having greater metal content within the macropores and/or disposed thereupon as evidenced by the lower uncrushed/crushed values.

TABLE 2

| Catalyst | Uncrushed, wt % | | | Crushed, wt % | | | Uncrushed/Crushed |
|---|---|---|---|---|---|---|---|
| System | Al | Si | Al/Si | Al | Si | Al/Si | (Al/Si)/(Al/Si) |
| A1 | 15.66 | 21.15 | 0.74 | 11.42 | 26.26 | 0.43 | 1.72 |
| A2 | 15.12 | 22.05 | 0.69 | 11.35 | 26.31 | 0.43 | 1.60 |
| A3 | 17.39 | 17.34 | 1.00 | 12.21 | 26.22 | 0.47 | 2.13 |

### Catalyst Activity During Polymerization:

The polymerization was conducted in a continuous gas phase fluidized-bed reactor having a 16.5 inch (41.9 cm) diameter with a bed height of approximately 12 feet (3.6 m). The fluidized-bed is made up of polymer granules. The gaseous feed streams of ethylene and hydrogen together with liquid comonomer were mixed together in a mixing tee arrangement and introduced below the reactor bed into the recycle gas line. The individual flow rates of ethylene, hydrogen and comonomer were controlled to maintain fixed composition targets. The ethylene concentration was controlled to maintain a constant ethylene partial pressure. The hydrogen was controlled to maintain a constant hydrogen to ethylene mole ratio. The concentrations of all the gases were measured by an on-line gas chromatograph to ensure relatively constant composition in the recycle gas stream.

The particular catalyst system was injected directly into the fluidized-bed using purified nitrogen as a carrier. Its rate of injection was adjusted to maintain a constant production rate of the polymer. The reacting bed of growing polymer particles is maintained in a fluidized state by the continuous flow of the make-up feed and recycle gas through the reaction zone. A superficial gas velocity of 1-3 ft/s (0.3 to 0.9 m/s) was used to achieve this. The reactor was operated at a total pressure of 300 psig (2068 kPa gauge). To maintain a constant reactor temperature, the temperature of the recycle gas is continuously adjusted up or down to accommodate any changes in the rate of heat generation due to the polymerization.

The fluidized-bed was maintained at a constant height by withdrawing a portion of the bed at a rate equal to the rate of formation of particulate product. The product is removed semi-continuously via a series of valves into a fixed volume chamber, which is simultaneously vented back to the reactor. This allows for highly efficient removal of the product, while at the same time recycling a large portion of the unreacted gases back to the reactor. This product is purged to remove entrained hydrocarbons and treated with a small stream of humidified nitrogen to deactivate any trace quantities of residual catalyst and cocatalyst.

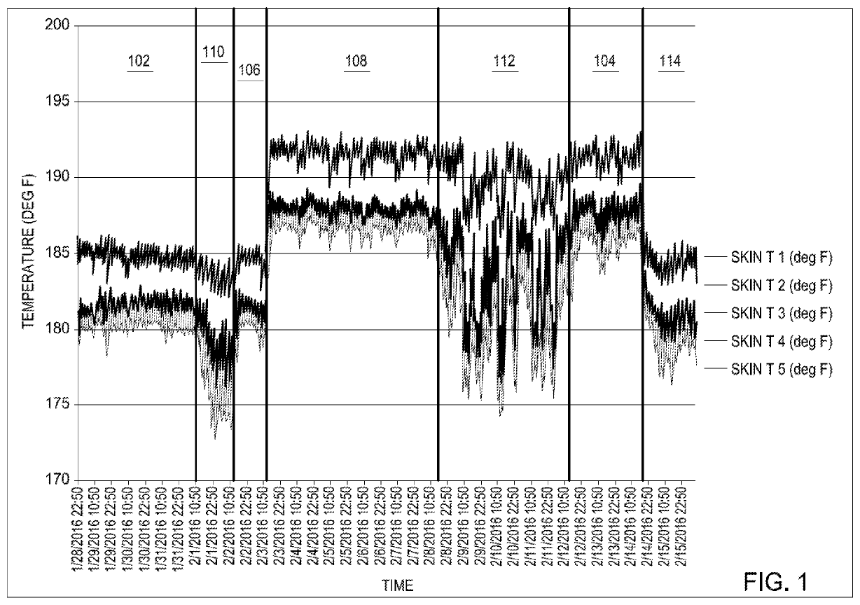

For monitoring skin temperature, a thermocouple is present on the outer surface the reactor but under the reactor insulation. The FIGURE is a graph illustrating skin temperature of a gas phase reactor versus time for polyethylene polymerizations using catalyst systems of the present disclosure. Reaction conditions using Catalyst Systems A1-A3 were performed under polymerization conditions to form a polyethylene composition having (1) a density of 0.920 g/cc and Melt Index of 1.0, or (2) a density of 0.935 g/cc and Melt Index of 0.5. Formation of 0.920 g/cc (MI=1.0) polyethylene copolymer versus 0.935 g/cc (MI=0.5) polyethylene copolymer can be controlled by adjusting the amount of comonomer fed into the reactor, e.g. a higher ratio of comonomer (hexene) to ethylene fed into the reactor promotes lower density polyethylene copolymers. For example, 0.920 g/cc polyethylene copolymer is promoted at a molar ratio of hexene:ethylene is about 0.009:1, whereas 0.935 g/cc polyethylene copolymer is promoted at a molar ratio of hexene:ethylene is about 0.0035:1. As shown in FIG. 1, formation of 0.920 g/cc polyethylene (102) and 0.935 g/cc polyethylene (104) performed with Catalyst System A1 does not form cold-bands as monitored by the skin temperature of the reactor. Similarly, formation of 0.920 g/cc polyethylene (106) and 0.935 g/cc polyethylene (108) performed with Catalyst System A2 also does not form cold-bands as monitored by the skin temperature of the reactor. However, formation of 0.920 g/cc polyethylene (110) and 0.935 g/cc polyethylene (112) performed with Catalyst System A3 indicates cold-bands as monitored by the skin temperature of the reactor. These cold-bands indicate risk of sheet formation on the wall of the reactor. As a control, formation of 0.920 g/cc polyethylene (114) with a control catalyst system was also performed. The control catalyst system is identical to the catalyst systems of the other examples but the catalyst of the control catalyst system was prepared a month prior to the polymerization experiments instead of soon before the polymerization experiments as in the other examples.

In several classes of embodiments of the invention, catalyst systems of the present disclosure provide increased metal content on the surfaces within voids of a catalyst support composition and, accordingly, less metal content on the outer surface of the catalyst support composition. The increased catalyst content within and/or on the support material does not substantially affect catalyst activity of catalyst systems of the present disclosure.

In several other classes of embodiments, catalyst systems and methods of the present disclosure provide reduced and/or eliminated sheeting and/or chunking on an inner reactor wall (skin) and dome of a reactor, as evidenced by reduced or eliminated cold-bands and/or positive skin thermocouple deviations. Reduced and/or eliminated sheeting and/or chunking with use of catalyst systems of the present disclosure provides operation of a reactor with reduced and/or eliminated reactor discontinuity events. Furthermore, in some embodiments, catalyst systems of the present disclosure provide reduced activator content of the catalyst systems, which provide decreased cost of production of the catalyst systems.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

We claim:

1. A process for preparing a catalyst system, the process comprising:
contacting one or more catalysts having a Group 3 through Group 12 metal atom or lanthanide metal atom with methylalumoxane and one or more support material compositions having a macroporosity from about 0.18 cc/g to about 0.30 cc/g to a concentration of methylalumoxane of about 4 mmol to about 15 mmol aluminum per gram of support material.

2. The process of claim 1, wherein the one or more catalysts are contacted with methylalumoxane and the one or more support material compositions in the presence of toluene.

3. The process of claim 2, further comprising removing a portion of the toluene after contacting.

4. The process of claim 1, wherein the one or more catalysts are selected from the group consisting of a metallocene catalyst compound, a bis(phenolate) catalyst compound, and combinations thereof.

5. The process of claim 1, wherein the one or more support material compositions comprise Al₂O₃, ZrO₂, SiO₂, SiO₂/Al₂O₃, SiO₂/TiO₂, silica-alumina, silica clay, silicon oxide/clay, or a combinations thereof.

6. The process of claim 1, wherein the methylalumoxane is present at a molar ratio of aluminum to catalyst metal of about 50:1 or less.

7. The process of claim 1, wherein the one or more support material composition is SiO₂, and the catalyst system has an uncrushed (Al/Si)/crushed (Al/Si) value of from about 1 to about 3 as determined by X-ray Photoelectron Spectroscopy.

8. The process of claim 1, wherein the one or more support material compositions have a macroporosity from about 0.22 cc/g to about 0.28 cc/g.

9. The process of claim 1, wherein the support material composition has a macroporosity of about 0.25 cc/g.

10. The process of claim 1, wherein the one or more support material compositions comprise a plurality of particles and one or more of the plurality of particles has a surface area from about 270 m²/g to about 350 m²/g and a pore volume from about 1.2 cc/g to about 3 cc/g.

11. The process of claim 10, wherein the one or more of the plurality of particles has a particle size diameter D50 value of from about 1 micron to about 5 microns.

12. The process of claim 1, wherein the one or more support material compositions comprise a plurality of particles and one or more of the plurality of particles has a surface area from about 700 m²/g to about 850 m²/g and a pore volume from about 0.6 cc/g to about 2.5 cc/g.

13. The process of claim 12, wherein one or more of the plurality of particles has a particle size diameter D50 value of from about 1 micron to about 5 microns.

14. The process of claim 1, wherein the one or more support material compositions have a particle size D50 value of from about 30 microns to about 60 microns.

15. The process of claim 1, wherein the one or more support material compositions have a particle size diameter D50 value of about 40 microns.

16. The process of claim 1, wherein the one or more catalysts are represented by the formula:
T_{y}CpₘMGₙX_{q}
wherein Cp is independently a cyclopentadienyl ligand or ligand structurally similar to cyclopentadienyl, M is a group 4 transition metal, G is a heteroatom group represented by the formula JR*_{z} where J is N, P, O or S, and R* is a linear, branched, or cyclic C1-C20 hydrocarbyl and z is 1 or 2, T is a bridging group, and y is 0 or 1, X is an anionic ligand, and m=1, n=1, 2 or 3, q=0, 1, 2 or 3, and the sum of m+n+q is equal to the oxidation state of the transition metal.

17. The process of claim 1, wherein the catalyst is an unbridged metallocene catalyst compound represented by the formula: Cp^{A}Cp^{B}M′X′ₙ, wherein each of Cp^{A} and Cp^{B} is independently selected from the group consisting of cyclopentadienyl ligands and ligands isolobal to cyclopentadienyl, one or both Cp^{A} and Cp^{B} may contain heteroatoms, and one or both Cp^{A} and Cp^{B} may be substituted by one or more R″ groups, wherein M′ is an element selected from the group consisting of Groups 3 through 12 and lanthanide Group, wherein X′ is an anionic ligand, wherein n is 0 or an integer from 1 to 4, wherein R″ is selected from the group consisting of alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, ether, germanium, and thioether.

18. The process of claim 1, wherein the catalyst is a bridged metallocene catalyst compound represented by the formula: Cp^{A}(A)Cp^{B}M′X′ₙ, wherein each of Cp^{A} and Cp^{B} is independently selected from the group consisting of cyclopentadienyl ligands and ligands structurally similar to cyclopentadienyl, one or both of Cp^{A} and Cp^{B} may contain heteroatoms, and one or both of Cp^{A} and Cp^{B} may be substituted by one or more R″ groups, wherein M′ is an element selected from the group consisting of Groups 3 through 12 and lanthanide Group, wherein X′ is an anionic ligand, wherein n is 0 or an integer from 1 to 4, wherein (A) is selected from the group consisting of divalent alkyl, divalent lower alkyl, divalent substituted alkyl, divalent heteroalkyl, divalent alkenyl, divalent lower alkenyl, divalent substituted alkenyl, divalent heteroalkenyl, divalent alkynyl, divalent lower alkynyl, divalent substituted alkynyl, divalent heteroalkynyl, divalent alkoxy, divalent lower alkoxy, divalent aryloxy, divalent alkylthio, divalent lower alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent lower hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether; wherein R″ is selected from the group consisting of alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, germanium, ether, and thioether.

19. The process of claim 1, wherein the catalyst is selected from the group consisting of:
dimethylsilyl-bis(tetrahydroindenyl) zirconium dichloride;
dimethylsilyl (tetramethylcyclopentadienyl)(cyclododecylamido)titanium dimethyl;
dimethylsilyl (tetramethylcyclopentadienyl)(cyclododecylamido)titanium dichloride;
dimethylsilyl (tetramethylcyclopentadienyl)(t-butylamido)titanium dimethyl;
dimethylsilyl (tetramethylcyclopentadienyl)(t-butylamido)titanium dichloride;
μ-(CH₃)₂Si(cyclopentadienyl)(1-adamantylamido)M(R)₂;
μ-(CH₃)₂Si(3-tertbutylcyclopentadienyl)(1-adamantylamido)M(R)₂;
μ-(CH₃)₂(tetramethylcyclopentadienyl)(1-adamantylamido)M(R)₂;
μ-(CH₃)₂Si(tetramethylcyclopentadienyl)(1-adamantylamido)M(R)₂;
μ-(CH₃)₂C(tetramethylcyclopentadienyl)(1-adamantylamido)M(R)₂;
μ-(CH₃)₂Si(tetramethylcyclopentadienyl)(1-tertbutylamido)M(R)₂;
μ-(CH₃)₂Si(fluorenyl)(1-tertbutylamido)M(R)₂;
μ-(CH₃)₂Si(tetramethylcyclopentadienyl)(1-cyclododecylamido)M(R)₂;
μ-(C₆H₅)₂C(tetramethylcyclopentadienyl)(1-cyclododecylamido)M(R)₂;
μ-(CH₃)₂Si(η⁵-2,6,6-trimethyl-1,5,6,7-tetrahydro-s-indacen-1-yl)(tertbutylamido)M(R)₂; and
mixtures thereof; where M is selected from a group consisting of Ti, Zr, and Hf; and R is selected from halogen or C1 to C5 alkyl.

20. The process of claim 1, wherein the process further comprises contact a second catalyst having a chemical structure different than the first catalyst with the methylalumoxane, the second catalyst having a Group 3 through Group 12 metal atom or lanthanide metal atom.

21. A process for polymerizing olefins to produce a polyolefin composition, the process comprising contacting at least one olefin with the catalyst system of claim 1 in a gas phase reactor and obtaining the polyolefin composition at a space time yield of about 14 lb/hr/ft³ or greater.

22. The process of claim 21, wherein the polymerizing is conducted at a temperature of from about 0° C. to about 300° C., at a pressure in the range of from about 0.35 MPa to about 10 MPa, and at a time up to about 300 minutes.

23. The process of claim 21, wherein the at least one olefin comprises ethylene, propylene, butene, pentene, hexene, heptene, octene, nonene, decene, undecene, dodecene, and mixtures thereof.

24. The process of claim 21, wherein the polyolefin composition has a polymer density of from about 0.930 g/cm³ or greater.

25. The process of claim 21, wherein the polyolefin composition has a melt index of 0.50 dg/min or less.
